(19) United States
(12) Patent Application Publication
(10) Pub. No.: US 2007/0281278 A1
(43) Pub. Date: Dec. 6, 2007

(54) Transfer coping for dental implants

(76) Inventors: Lars Jorneus, Frillesas (SE); Steven M. Hurson, Yorba Linda, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/444,524

(22) Filed: May 31, 2006

(51) Int. Cl. A61C 8/00

(52) U.S. Cl. 433/173

(57) ABSTRACT

An impression coping is provided for taking an impression of an implant installed in a patient's mouth. The impression coping comprises an engagement portion, a cover and an impression portion. The engagement portion is adapted to be inserted within an internal cavity of the implant. The engagement portion has a plurality of axially extending protrusions positioned around the periphery for engaging corresponding channels within the internal cavity of the implant. The engagement shaft is thus configured to register the internal orientation of the implant within a patient's jaw. The impression portion of the coping includes one or more embedment features adapted to be embedded in a dental impression material for taking a dental impression thereof.

### BACKGROUND OF THE INVENTION

1. Field of the Invention

The present invention relates generally to dental impression copings used in implant dentistry to take impressions of a dental implant site from which accurate models can be constructed. More particularly, the invention relates to an improved pick-up type impression coping.

2. Description of the Related Art

Restoration of an edentulous area of the mouth serves multiple functions, including improved aesthetics, improved mastication, maintenance of crestal bone, and providing for an occlusal stop for a reproducible bite. Restoration can be accomplished using a standard bridge, a removable appliance (a partial or full denture), or a dental implant.

Dental implantation is a procedure for replacing a missing tooth using a dental implant. A dentist reviews radiographs and dental models to determine the proper placement and axial alignment of the implant. The placement of the implant has historically been accomplished in three stages. In a first second stage, a dental surgeon accesses the bone through the mucosal tissue. With the use of a prefabricated stint, the surgeon drills or bores out the maxillary or mandibular bone. The implant is then either pressed or screwed into the bone. A healing cap is typically then placed over the implant and the surrounding mucosal tissues are sutured over the healing cap. This provides for a biologically closed system to allow osteointegration of bone with the implant. Complete osteointegration typically takes anywhere from four to ten months.

Stage two, involves a second surgical procedure during which the dental surgeon makes an incision in the mucosal tissue to expose the osteointegrated implant. The healing cap is removed and a temporary abutment, having a height at least equal to the thickness of the gingival tissue is coupled to the implant. In a modified procedure an appropriately sized final abutment is coupled to the implant and a healing cap or temporary restoration may be placed over the final abutment. Once the abutment is secured an immediate mold or impression may be taken. In a modified procedure, the impression may be taken within one to two weeks after stage three. The impression is used to record the axial position and orientation of the implant, which is then reproduced in a stone or plaster analogue of the patient's mouth. The main objective of the impression is to properly transfer the size and shape of adjacent teeth in relation to the permanently placed implant and the precise configuration and orientation of the abutment to the dental technician. The plaster analogue provides the laboratory technician with a precise model of the patient's mouth, including the orientation of the implant fixture relative to the surrounding teeth. Based on this model, the technician constructs a final restoration. Stage three, in the restorative process, involves replacing the temporary healing abutment with the final restoration or attaching the restoration to a previously placed final abutment.

As noted above, during stage three, a mold or impression is taken of the patient's mouth to accurately record the position and orientation of the implant site and to provide the information needed to fabricate the restorative replacement and/or intermediate prosthetic components. There are several conventional methods for taking this impression.

One method involves a conventional impression coping. Impression copings have an impression portion adapted to form a unique or indexed impression in the impression material and a base portion having mating indexing means adapted to mate with the exposed indexing means of the implant or prosthetic abutment. In use, the impression coping is temporarily secured to the exposed proximal end of the implant fixture such that the mating indexing means of the impression coping and implant are interlockingly mated to one another. Typically, a threaded screw or bolt is used to temporarily secure the impression coping to the implant fixture.

Once the impression coping is secured to the implant fixture, an impression of the impression coping relative to the surrounding teeth is taken. Typically, this involves a “U” shaped tray filled with an impression material that is placed in the patient's mouth over the implant site. The restorative doctor presses down on the tray, squeezing the impression material into the implant site and around the impression coping. Within a few minutes, the impression material cures or hardens to a flexible, resilient consistency. The impression tray is then removed from the patient's mouth to reveal an impression of the implant site and the impression coping. The restorative dentist then removes the impression coping from the patient's mouth and transfers the impression coping back into the impression material, being careful to preserve the proper orientation of the indexing means.

Another method typically involves a conventional pick-up coping. Pick-up copings are similar to the impression copings described above; except that a pick-up coping typically includes an embedment portion adapted to be non-removably embedded within the impression material. Typically, the embedded portion comprises a protuberant “lip” or similar embedment projection at a coronal portion of the coping. This allows for “grabbing” or traction of the impression material as the tray is being removed from the patient's mouth. The pick-up copings are “picked up” and remain in the impression material when the tray is removed from the patient's mouth. In addition, the pick-up copings are often secured to the implant by a bolt or screw. An end of the screw is configured to extend through an opening in “U” shaped tray filled with impression material. Accordingly, after the tray is placed over the coping, the screw can be loosen to decouple the coping from the implant and allowing the coping to be picked up with the tray.

Yet another method for taking an impression involves an impression or transfer cap. Impression or transfer caps are placed over or on the built-up part of the abutment or the implant and remain in the impression material when the tray is removed. There are several different types of transfer caps. One type of transfer cap has a tapered inner surface, which is adapted in form and size to the built-up part or abutment of the implant. This cap has an inner surface, which has indentations or slots, which correspond to indentation or slots present on the abutment. The cap is attached to the abutment with resilient flaps or tongues that extend around the abutment. An example of such a cap is illustrated in U.S. Pat. No. 5,688,123 to Meiers et al.

### SUMMARY OF THE INVENTION

U.S. Pat. No. 6,382,977 describes one example of a pick up coping. This pick up coping has a lower portion that is configured to snap into an internal cavity formed in an implant. An advantage of this pick up coping is that the snap in features are positioned within the implant and are thus are not exposed to the patient as with the transfer cap disclosed in Meirs et al. discussed above. However, the snap in features of this pick up coping have proven difficult and expensive to manufacture. A need, therefore, exists for a pick up coping that can be inserted into an internal cavity of an implant and yet be commercially manufactured in a cost effective manner.

Accordingly, one aspect of the present invention comprises an impression coping for recording the position and orientation of an implant installed in a patient's jawbone. The coping includes a distal portion that has at least one impression flange that includes a surface that extends generally transverse to a longitudinal axis of the impression coping. The coping also includes a proximal portion comprising a hollow member that is formed at least in part by a sidewall having an outer surface and an inner surface that defines a cavity that extends generally along the longitudinal axis of the impression coping. The side wall has a thickness defined between the outer and inner surfaces. The side wall has at least one thinned section that extends in a generally longitudinal direction such that a portion of the side wall can be deflected inwardly towards the longitudinal axis of the impression coping. A base member is positioned between distal and proximal portions of the impression coping. In one embodiment, longitudinal ridges can be provided on the outer surface generally opposite the thinned sections.

Another aspect of the present invention is a dental implant assembly that comprises a dental implant and an impression coping. The dental implant comprises a body portion and a top surface with an internal cavity with an opening located at the top surface. The impression coping comprises a first end and a second end. The first end includes an impression portion configured to be embedded in an impression material. The second end comprises a hollow member that is formed in part from a sidewall having an outer surface and an inner surface that defines a cavity that extends generally along the longitudinal axis of the impression coping. The side wall has a thickness defined between the outer and inner surfaces. The side wall has at least one thinned section that extends in a generally longitudinal direction such that at least a portion of the side wall can be deflected inwardly towards the longitudinal axis of the impression coping as the second end is inserted into the internal cavity of the dental implant. In one embodiment, at least one longitudinal ridge can be provided on the outer surface generally opposite the thinned sections.

Another aspect of the present invention is an impression coping for recording the position and orientation of an implant installed in a patient's jawbone. The impression coping comprises a proximal end and a distal end. The proximal end comprises a generally tubular section formed by a tubular wall. The tubular wall forms one or more lever arms positioned between thinned sections formed in the tubular wall. The proximal end further includes an index boss or recess formed therein for engaging a corresponding mating index boss or recess formed on the implant. The distal end including at least one impression flange that includes a surface that extends generally transverse to a longitudinal axis of the impression coping.

Certain objects and advantages of the invention have been described above for describing the invention and the advantages achieved over the prior art. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

These and other features of the invention will now be described with reference to the drawings of the preferred embodiments, which are intended to illustrate and not to limit the invention, and in which:

FIG. 1 is a side view of a dental implant having certain features and advantages according to the present invention;

FIG. 2 is a cross-sectional view of the dental implant of FIG. 1 showing the inner bore;

FIG. 3 is a top view of the dental implant of FIG. 1;

FIG. 4 is a side view of an impression coping having features and advantages according to the present invention.

FIG. 5 is an adjacent side view of the impression coping of FIG. 4.

FIG. 6 is a bottom view of the impression coping of FIG. 4.

FIG. 7 is a detailed portion of the bottom view of FIG. 6.

FIG. 8 is a top view of the impression coping of FIG. 4.

FIGS. 9A-B are partial cross-sectional time assembly views illustrating the impression coping of FIG. 4 being inserted into the implant.

FIG. 10 is a cross-sectional view of an impression tray filled with impression material with an impression coping embedded therein.

### DETAILED DESCRIPTION OF THE PREFERRED EMBODIMENTS

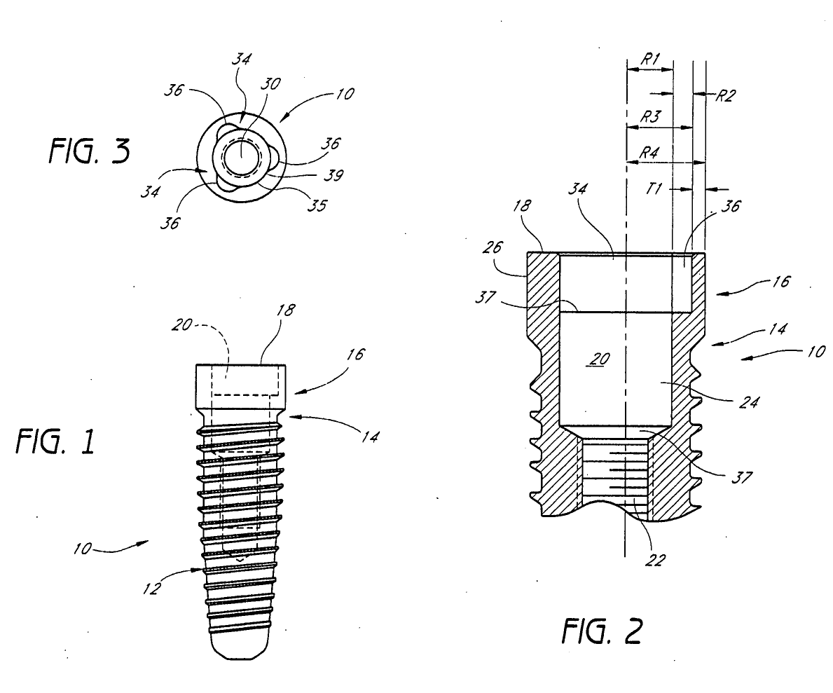

The embodiments described herein relate to methods and devices that relate to taking an impression of a dental implant which is implanted in a patient's jaw. FIGS. 1-3 illustrate one exemplary embodiment of a dental implant 10, particularly suited for receiving a dental impression coping having certain features and advantages according to one embodiment of the present invention. The dental implant 10 is described in detail in U.S. Pat. No. 6,382,977, and U.S. Pat. No. 6,733,291, the disclosure of which are hereby incorporated herein by reference.

As shown in FIGS. 1-3, the implant 10 can have an outer surface that is preferably divided into three regions: a body portion 12, a neck region 14, and a top portion 16. The body portion 12 preferably includes threads, and represents the portion of the implant 10 that is placed in either the mandible or the maxilla. A hollow inner cavity 20 can extend from the top portion 16 through a portion of the body portion 12 of the implant 10 for receiving and supporting the final prothesis and various intermediate components. As shown, the body portion 12 of the implant can be substantially cylindrical or slightly tapered; however, the body portion 12 could also assume a conical shape or other known implant shapes, as desired. The threads of the body portion 12 can preferably match preformed threads formed along the inner surface of an osteotomy formed in the patient's jawbone. However, the implant 10 could also be designed so as to be self-tapping. The top portion 16 of the implant can be substantially cylindrical and can have a top surface 18 that is substantially flat. In other embodiments, the top portion 16 can be conical and/or the top surface 18 can be contoured or slanted. It is also anticipated that the top surface 18 can be non-round and/or asymmetrical (i.e. the top portion 16 has a non-round or asymmetrical cross-sectional profile).

As best seen in FIG. 2, the neck 14 lies between the body portion 12 and the collar 16. The neck 14 can have a diameter that is less than the diameter of the collar 16. The collar 16 of the implant can be substantially cylindrical and has a top surface 18 that is substantially flat. The collar 16 is defined in part by a vertical side wall 26 that is preferably greater than 1 millimeter in length. In another embodiment, the length of the collar is approximately 2.0. In another embodiment, the implant 10 is formed without the neck 14 and the collar 16 has a side wall 26 with a length between about 0.5 and 1.5 millimeters.

As mentioned above, the implant 10 can include an inner cavity 20 for receiving and supporting the final tooth prosthesis. The inner cavity 20 can include a threaded chamber 22, a post receiving chamber 24, and an index chamber 34.

The threaded chamber 22 can be sized and configured so as to receive a bolt (not shown). The bolt can be used to temporarily or permanently attach a dental component, such as, for example, a temporary healing abutment or a final restoration to the implant 10. The post receiving chamber 24 can be sized and configured to engage a corresponding post structure in an impression coping or another mating component (e.g., a final abutment). Preferably, the diameter of the threaded chamber 22 is smaller than the diameter of the post receiving 24.

The index chamber 34 is best seen in FIGS. 2 and 3. In the illustrated arrangement, the indexing chamber 34 can be substantially cylindrical chamber 35 with three engagement channels 36 that extend from the top surface 18 to the bottom of the index portion 34. It should be appreciated, however, that the index chamber can be formed with any number of engagement channels spaced apart about the periphery of the cylindrical chamber. The three engagement channels 36 can be substantially half circular in shape and can be symmetrically situated around the periphery of the cylindrical portion 35. Preferably, the engagement channels 36 are located approximately 120° apart from each other relative to a center axis 30 of the implant 10. The cylindrical portion 35 has a first radius R1 and the semi-circular channels 36 have a second radius R2. The ratio α of the first radius R1 to the second radius R2 preferably is between 2:1 and 4:1. In the preferred embodiment the ratio α, is about 3:1. This arrangement is preferred to minimize the stress concentrations in the dental implant 10. To reduce stress concentrations further, the interfaces 39 between the channels 36 and the cylindrical portion 35 are preferably rounded.

The index chamber 34 can be dimensioned to be as large as possible without significantly compromising the structural integrity of the vertical side wall 26. This arrangement is preferred because it increases the surface area of the indexing chamber 34. The larger surface area results in a more stable connection between the implant 10 and the mating dental component. Accordingly, the indexing chamber 34 has a third radius R3, which is approximately equal to the first radius R1 plus the second radius R2. The third radius R3 is sized such that the thickness T1 (i.e., the radius R4 of the implant minus R3) of the vertical wall 26 is greater than a minimum value, which provides sufficient structural integrity for the implant 10. For an implant made of dental grade titanium alloy, the preferably minimum value is approximately 0.4-0.8 millimeters. Another preferred aspect of the shape of the indexing chamber 34 is the ratio between the radius R4 of the implant 10 and the radius R2 of the channels 36. More specifically, the ratio between the radius R4 of the implant and the radius R2 of the channels 36 is preferably between 4:1 to 5:1. In the preferred embodiment, the ratio is about 4.5:1.

In use, the indexing chamber 34 can be designed to mate with corresponding indexing features formed on various mating components, such as, for example, an impression coping or a final abutment. By engaging the indexing features of the mating component with the indexing chamber 34 of the implant, one can register the orientation of the implant. In addition, the engagement channels 36 of the index chamber 34 serve to prevent relative rotation between the mating component and the implant 10. It should be appreciated however, that the index chamber 34 can be formed in a wide variety of other suitable symmetric or non-symmetric shapes that may be used with efficacy, giving due consideration to the goals of providing repeatable indexing and anti-rotation of mating components. For example, the index chamber 34 could comprise a hexagonal recess or hexagonal protrusion that is situated on the top surface 18 of the implant.

The inner cavity 20 can also include a post-receiving chamber 24, which lies between the indexing chamber 34 and the screw chamber 22. The post-receiving chamber 24 is preferably substantially cylindrical. The diameter of the post-receiving chamber 24 is preferably less than the diameter of the indexing chamber 34. The post-receiving receiving chamber 24 may include a chamfered region 37, which is adjacent the threaded region 22. The post-receiving chamber 24 is sized and dimensioned to receive a post that is attached to a mating dental component. The post and the post-receiving chamber 32 provide additional frictional interface between the mating component and the implant as well as lateral support, which prevents the mating component from tipping off the implant. However, it should be appreciated that in some embodiments the implant 10 can be formed without the post-receiving chamber 24.

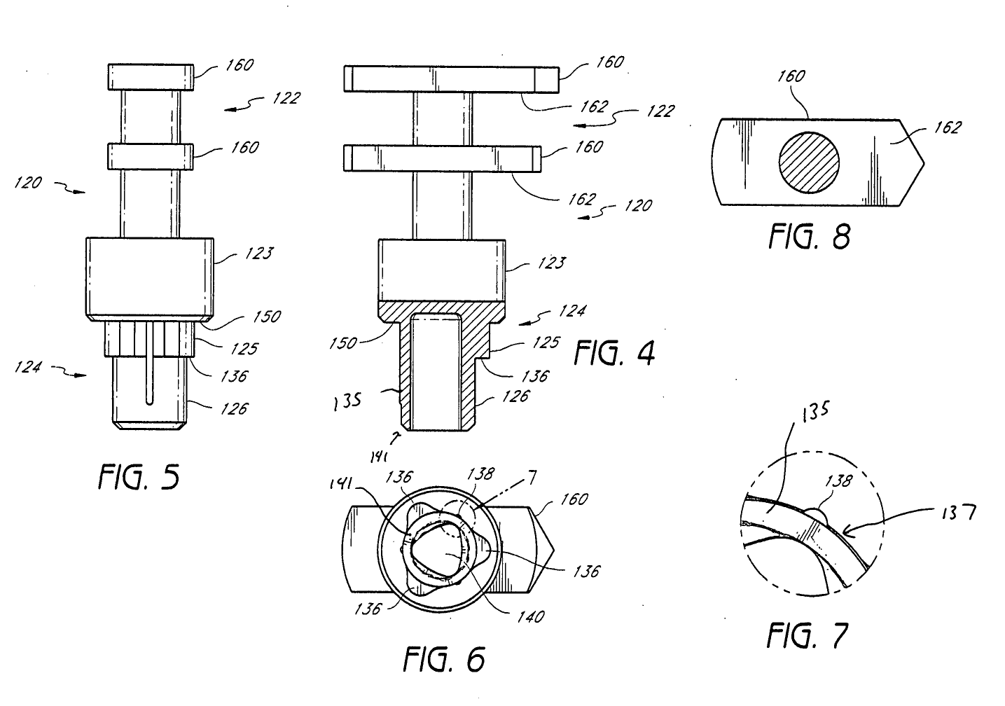

FIGS. 4-8 illustrate one embodiment of an impression coping 120 designed to mate with the above described implant. As discussed above, by mating the impression coping 120 with the indexing chamber 34 of the implant, one can register the orientation of the internal implant configuration and thereby determine the three-dimensional orientation of the implant within a patient's jaw. This information can then be used to construct a final restoration as is known in the art.

The illustrated coping 120 is sized and dimensioned to mate with the implant 10 described above. Advantageously, due to its friction fit feature the coping 120 may be configured and used as a pick-up type coping that mates with the implant 10 described above, but does not require modification of the impression tray to use. Alternatively, the impression coping 120 may be configured for use as a transfer coping. The impression coping 120 is preferably made of resilient moldable plastic and/or polymer, such as, for example, polycarbonate. In one embodiment, the coping 120 can be made radiopaque by adding a radiopaque markers (not shown) to the coping and/or mixing a radiopaque material into the material used to form the coping. In this manner, the coping can be seen under an X-ray.

As shown in FIGS. 4-5, in the illustrated embodiment, the impression coping 120 can include an impression region 122, a cover 123, and an engagement shaft 124. The bottom surface 150 of the cover 123 can be substantially flat and can have a diameter approximately equal to the diameter of the top surface 24 of the implant 10. The cover 123 can be substantially circular with the flat, bottom surface 150 and that preferably has the same outer diameter as the top portion 18 of the implant 10. Accordingly, when the impression coping 120 is engaged with the implant 10, the bottom surface 150 of the cover 123 will preferably be resting in flush contact with the implant 10. In this manner, precise orientation and placement of the impression coping 120 can be provided. In modified embodiments, the bottom surface 150 can have a shape that is different (e.g., larger, smaller, or differently shaped) than the top surface of the implant 10. As with the implant 10, the bottom surface 150 can also have a non-round or asymmetric shape and/or a shape that is contoured or slanted with respect to a longitudinal axis.

Extending from the bottom surface 150 is the engagement shaft 124, which can be configured to fit within and engage the inner cavity 20 of the implant 10. The engagement shaft 124 can be substantially cylindrical and comprises an upper, index portion 125 and a lower post portion 126. The index portion 125 of the engagement shaft 124 ca further include a plurality of axially oriented protrusions 136 which are configured to fit in and engage corresponding channels 36 in the index chamber 34 of the implant 10. Accordingly, in the preferred embodiment for mating with the above described implant, three semi-circular protrusions 136 are arranged around the perimeter of the index portion 125 at approximately 120° apart relative to the center axis of the impression coping 120. The protrusions 136 preferably extend along the entire length of the index portion 125 and have a half circular shape. In use, these protrusions 136 mate with and register the internal orientation of the implant 10. In modified embodiments, the index portion 125 can be modified to correspond to the shape of the index chamber 34. E.g., if the index chamber has a hexagonal or similar shape the index portion 124 can have similar shape. In still another embodiment, the top surface of the implant can be provided with a index protrusion (e.g., a hexagonal protrusion), which can be received within a corresponding recess formed in the bottom surface 150. Accordingly, like the indexing chamber of the implant 10, the indexing portion 124 of the impression coping 120 may be formed in a wide variety of other shapes that may be used with efficacy, giving due consideration to the goals of providing repeatable indexing and anti-rotation of mating components.

The post portion 126 extends from the indexing portion 125 and can be configured to fit within the post-receiving chamber 32 of the implant. The engagement shaft 124 can be further configured to provide an interference fit or friction fit between impression coping 120 and the post chamber 24 of the implant 10. In the preferred embodiment, a friction fit is formed between the two components. With reference to FIG. 6, the engagement shaft 124 can be hollowed out to allow the walls of the engagement shaft 124 to be flexible in the upper, thereby accommodating a range of tolerance of the internal cavity 20 of the implant 10. In one embodiment, an inner cavity 140 in the engagement shaft 124 is formed in the shape of a generally equilateral triangular cylinder extending from the bottom surface of the engagement shaft 124 to proximate the bottom surface 150 of the cover 123. The cavity 140 can be oriented such that the points of the triangular cavity are generally centered between the protrusions 136 located on the outside of the engagement shaft 124. The vertical walls of the engagement shaft 124 can be made thinnest at these points, thereby providing flexibility to the engagement shaft 124 in the regions between the protrusions 136 while maintaining more stability around the protrusions 136. It should be appreciated however, that the hollow cavity 140 can be formed in a wide variety of other suitable symmetric or non-symmetric shapes that may be used with efficacy, giving due consideration to the goals of providing flexibility to the walls of the engagement shaft 124 to enhance the friction fit over a range of tolerances for the implant internal cavity.

Thus, in one embodiment, the shaft 124 forms a tubular wall 135 that includes at least one, and more preferably, a plurality of thinned regions 137 that extend generally along the longitudinal axis of the shaft 124. The thinned regions 137 facilitate the tubular wall 135 being deflected inwardly towards the longitudinal axis of the impression coping 120. In one embodiment, the regions of the tubular wall between the thinned regions act as lever arms, which can be deflected inwardly toward the longitudinal axis. When portions of the shaft 124 are deflected inwardly, they exert a radial force which retain the shaft 124 within the cavity of the implant 10.

As illustrated in FIG. 7, the engagement shaft 124 can further include one or more smaller, axially oriented protrusions 138 positioned around the periphery of the engagement shaft generally corresponding to the triangular points of the inner cavity 140 for further facilitating a friction fit between the implant cavity 20 and the engagement shaft 124. Preferably, the protrusions or ridges 138 are positioned generally opposite to the thinned regions of the tubular wall. The protrusions 138 can be dimensioned such that the as the coping 120 is inserted into the cavity of the implant the protrusions 138 are deflected inwardly as the thinned portions 137 allow flexing of the tubular wall. In this manner, engagement shaft 124 can act as a radial spring creating a radial force that maintains the coping 120 coupled to the implant. In such an embodiment, the outer diameter of the engagement shaft 124 (excluding the protrusions 138) can have a diameter that is slightly smaller than the cavity of the implant such that without the protrusions 138 a slip fit would be formed between the two components.

The above described engagement shaft 124 has several advantages. For example, the shaft 124 and the coping 120 itself can provide for a friction fit without difficult to form parts such as those described in U.S. Pat. No. 6,382,977. Accordingly, the coping 120 can be formed from injection molding. In particular, the engagement shaft 124 as compared to the prongs described in the '977 patent can be formed from a substantially continuous body which facilities formation by injection molding. This reduces the cost of the coping 120 and allows it to be designed for single use applications in which the coping is disposed after one use.

As shown in FIGS. 4-7, the end of the shaft can also include a tapered region 141.

As shown in FIGS. 4, 5 and 8, the impression coping 120 can further include an impression region 122. The impression region 122 preferably includes one or more embedment feature(s) 160. The embedment feature(s) 160 facilitate(s) the gripping and retention of the impression coping 120 within an impression tray. Preferably, the one or more embedment feature(s) 160 comprise(s) an interference surface 162 or similar projection extending transversely from the longitudinal axis of the impression coping 120, such that embedment feature(s) 160 may grab the impression material as it is being removed from the patient's mouth. In the illustrated embodiment, the embedment features 160 comprise one or more flanges with interference surfaces 162, which are positioned the distal end impression coping 120. The interference surfaces 162 of the impression coping 120 facilitate mechanical interlocking between the impression material and the impression coping 120. As shown in FIG. 8, the shape of the embedment features 160 may be asymmetrical to further provide information regarding the configuration of the implant within the patient's jaw. In certain embodiments, the embedment feature 160 may include a plurality of through holes, which extends through the four corners of the embedment feature 160, for further facilitating retention of the impression coping 120 in the impression material. Alternatively, the embedment feature 160 may include a plurality of slots extending through the corners of the embedment features 160 or a criss-cross or mesh like on the interference surface 162 to further facilitate retention of the impression coping 120 in the impression material.

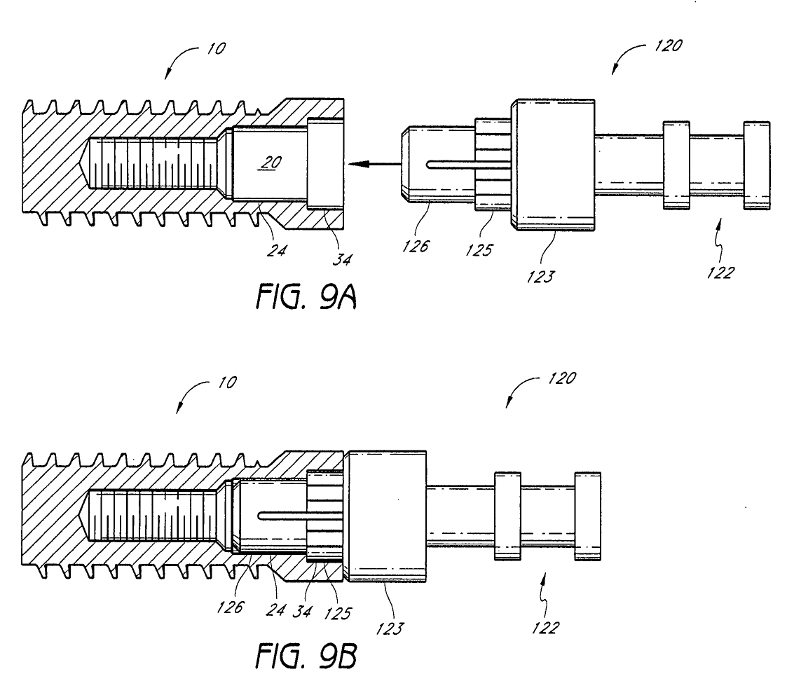

Referring to FIGS. 9A-B, to attach the impression coping 120 to the implant 10 during stage II, the surgeon simply places the impression coping 120 over the implant 10 and pushes the engagement portion 124 of the coping 120 into the implant 10. As mentioned above, the protrusions 136 of the coping 120 engage the channels 36 in the implant 10 in a friction fit, thereby providing retention of the implant 10 and registering the internal configuration of the implant. The post region 125 extends into the post receiving region 24 of the implant 10 and may be sized to engage the post receiving region 24 in a friction fit, thereby enhancing the retention of the impression coping 120 within the implant. The length of the engagement portion 124 of the impression coping 120 is preferably smaller than the depth of the implant inner cavity 20 such that when the impression coping 120 and implant 10 are engaged, the cover 123 is mated against the top surface 18 of the implant 10. Clinically and advantageously, the oral surgeon can be assured of the proper placement of the impression coping 120 because the impression coping 120 may only engage the implant if the protrusions 136 and engagement channels 36 are properly aligned. In addition, the friction fit between the implant 10 and the impression coping 120 when properly aligned provides improved tactile confirmation that the impression coping 120 is properly seated on the implant 10. This tactile confirmation is especially important for posterior prosthetics where visibility and working space are often compromised.

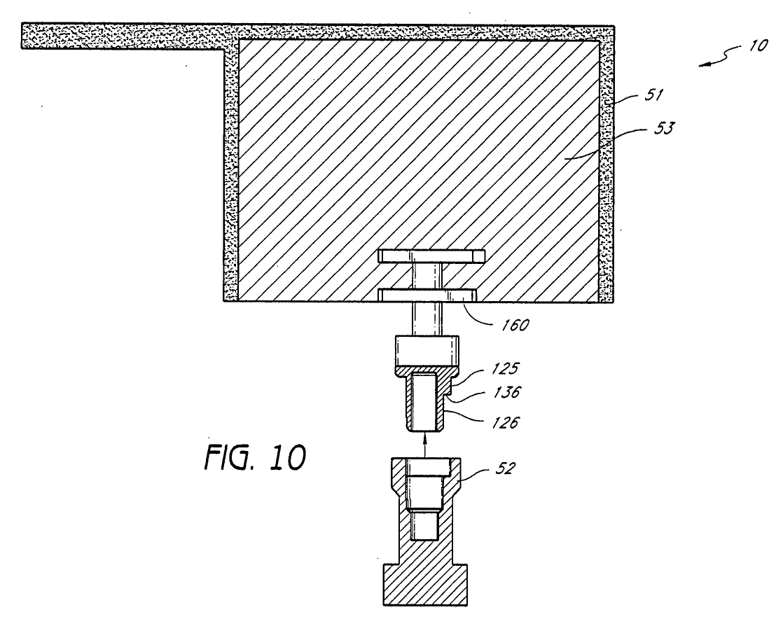

As shown in FIG. 10, once the impression coping 120 is attached to the implant 10 a “U” shape impression tray 51 is loaded with an impression material and is placed over the coping, causing the coping to be embedded into the impression material. The embedment features 160 of the impression portion 122 aid in embedding the impression coping 120 securely within the impression material and/or functions as an insertion indexing system if the coping is removed from the impression material and later reinserted.

After the impression material sets up or hardens, the impression tray is removed from the patient's mouth. In a pick up type impression the coping and implant are configured so that the friction force created by the engagement portion 124 of the coping 120 and the implant 10 is overcome by the retention force between the impression material and the embedment features 160 of the coping 120 and the impression coping remains embedded in the impression material. To help ensure that the coping 120 disengages from the implant 10, the protrusions 136 are preferably rounded.

The impression containing the coping 120 is then delivered to a dental technician for fabrication of the prosthetic tooth. The dental technician attaches an implant analog to the exposed engagement portion 124 of the embedded impression coping 120. The model is completed by pouring dental stone or any modeling material in the impression and around the implant analog 52. When the modeling material is set, the model is separated from the impression with the implant analog interlocked in the modeling material 53 (see FIG. 12). The analog 52 is properly positioned in the modeling material 53 to allow the dental technician to accurately create a prosthetic tooth in proper alignment and with proper occlusal length.

The dental implants and copings can be provided as part of a kit. In one embodiment, the kit includes an implant and a coping configured to mate with the implant. In another embodiment, the kit includes implants of various sizes and copings of various sizes configured to mate with the implants. In another embodiment, the kit can include copings of different sizes and configurations configured to mate with a signal implant. In yet another embodiment, the kit can include copings of various sizes and configurations.

Although invention has been disclosed in the context of certain preferred embodiments and examples, it will be understood by those skilled in the art that the present invention extends beyond the specifically disclosed embodiments to combinations, sub-combinations, other alternative embodiments and/or uses of the invention and obvious modifications and equivalents thereof. Thus, it is intended that the scope of the present invention herein disclosed should not be limited by the particular disclosed embodiments described above, but should be determined only by a fair reading of the claims that follow.

What is claimed is:

1. An impression coping for recording the position and orientation of an implant installed in a patient's jawbone comprising:
a distal portion that includes at least one impression flange that includes a surface that extends generally transverse to a longitudinal axis of the impression coping;
a proximal portion comprising a hollow member that is formed at least in part by a sidewall having an outer surface and an inner surface that defines a cavity that extends generally along the longitudinal axis of the impression coping, the side wall having a thickness defined between the outer and inner surfaces, the side wall having at least one thinned section that extends in a generally longitudinal direction, the side wall also including at least one elongated ridge that extends along the outer surface of the hollow member in a generally longitudinal direction generally opposite the thinned section of the wall; and
a base member positioned between distal and proximal portions of the impression coping.

2. The impression coping of claim 1, wherein the proximal portion further comprises means for indexing an indexing feature of a dental implant.

3. The impression coping of claim 1, wherein the proximal portion further comprises a plurality of axially oriented protrusions spaced around the outer surface of the hollow member.

4. The impression coping of claim 3, wherein the proximal portion includes three axially oriented protrusions substantially equidistantly spaced apart around the periphery of the hollow member.

5. The impression coping of claim 4, wherein said protrusions have an outer surface that has a semi-circular shape.

6. The impression coping of claim 4, wherein at least a portion of the cavity has the shape of an equilateral triangular cylinder.

7. The impression coping of claim 6, wherein coping includes three thinned sections that are located between the three axially oriented protrusions.

8. The impression coping of claim 7, wherein the coping includes three ridges that are located generally between the three axially orientated protrusions.

9. The impression coping of claim 1, wherein a portion of the side wall can be deflected inwardly towards the longitudinal axis of the impression coping.

10. An dental implant assembly comprising:
a dental implant comprising a body portion and a top surface with an internal cavity with an opening located at the top surface; and
an impression coping comprising a first end and a second end, the first end including an impression portion configured to be embedded in an impression material, the second end comprising a hollow member that is formed in part from a sidewall having an outer surface and an inner surface that defines a cavity that extends generally along the longitudinal axis of the impression coping, the side wall having a thickness defined between the outer and inner surfaces, the side wall having at least one thinned section that extends in a generally longitudinal direction and at least one elongated ridge that extends along the outer surface of the hollow member in a generally longitudinal direction generally opposite the thinned section of the wall such that the at least one elongated ridge can be deflected inwardly towards the longitudinal axis of the impression coping as the second end is inserted into the internal cavity of the dental implant.

11. The dental implant assembly of claim 10, wherein the dental implant further includes an index box or recess and the impression coping further includes a corresponding index recess or box configured to mate with the index box or recess of the dental implant.

12. The dental implant assembly of claim 10, wherein the dental implant and the impression coping include means for indexing the impression coping with the dental implant.

13. The dental implant assembly of claim 10, wherein the second end further comprises a plurality of axially oriented protrusions spaced apart around the outer surface the side wall, the plurality of axially orientated protrusions configured to mate with corresponding axially orientated channels formed in the cavity of the dental implant.

14. The dental implant assembly of claim 13, wherein the side wall include a plurality of thinned sections that are positioned between the plurality of axially orientated protrusions.

15. An impression coping for recording the position and orientation of an implant installed in a patient's jawbone, the impression coping comprising a proximal end and a distal end, said proximal end comprising a generally tubular section formed by a tubular wall, the tubular wall forming one or more lever arms positioned between thinned sections formed in the tubular wall, the proximal end further including an index boss or recess formed therein for engaging a corresponding mating index boss or recess formed on the implant, the distal end including at least one impression flange that includes a surface that extends generally transverse to a longitudinal axis of the impression coping.

16. The impression coping of claim 15, further comprising at least one elongated ridge that extends along the outer surface of the tubular section in a generally longitudinal direction.

17. The impression coping of claim 16, wherein the at least one elongated ridge is generally opposite one of the thinned sections of the tubular wall.

18. The impression coping of claim 17, wherein the index boss or recess includes a plurality of axially oriented protrusions spaced apart around the outer surface of the tubular

19. The impression coping of claim 18, the plurality of axially orientated protrusions are located between the thinned sections of the tubular wall.
